(19) United States
(12) Patent Application Publication
(10) Pub. No.: US 2023/0233883 A1
(43) Pub. Date: Jul. 27, 2023

(54) Personal protection equipment (PPE)) for air purification

(71) Applicant: PRASANNA DINKAR SOHALE, Nagpur (IN)

(72) Inventor: PRASANNA DINKAR SOHALE, Nagpur (IN)

(21) Appl. No.: 17/999,928

(22) PCT Filed: Sep. 25, 2020
(86) PCT No.: PCT/IN2020/050822

§ 371 Date: Nov. 27, 2022

(30) Foreign Application Priority Data
May 27, 2020 (IN) 202021022111

(51) Int. Cl. A62B 7/10; B01D 47/02; B01D 46/10

(52) U.S. Cl. CPC A62B 7/10; B01D 47/021; B01D 46/10

(57) ABSTRACT

A personal protection equipment (PPE) for air purification is disclosed. The PPE includes an apparatus. The apparatus includes a filter and a scrubber unit. The filter is configured to filter the air for removing dust from the air. The scrubber unit is configured to purify the air before a user breaths the air. The scrubber unit includes a sparger through which the filtered air is pumped and bubbled in a water solution of polymer to trap remaining contaminants in the air and the contaminants free or improved quality air is sent to the user for breathing.

### BACKGROUND

### Technical Field

The embodiment herein generally relates to a personal protection equipment (PPE-scrubber type) and more particularly, to a personal protection equipment (PPE) for air purification.

### Description of the Related Art

Atmosphere air gets contaminated due to dust, microorganisms, viruses, and toxic fumes hence it is necessary to have an equipment to purify air before it reaches near human's inhalation zone. In existing personal protection equipment, it is challenging to eliminate a COVID-19 virus as the COVID-19 virus is a novel virus and till date there is no cure for the COVID-19, the only way a person can protect themselves from the COVID-19 virus is to maintain social distancing, wearing face mask, and sanitizing their hands often. The existing personal protection equipments is useful to filter less harmful bacteria and virus but they are not designed for other harmful virus. Other drawbacks of wearing face mask is that the user gets suffocated within minutes of wearing the face mask and the user tends to remove the face mask despite the threats that the user might come in contact with the harmful viruses like COVID-19 virus.

Accordingly, there remains a need for a personal protection equipment (PPE) for air purification.

### SUMMARY

Accordingly, the disclosure provides a personal protection equipment (PPE) for air purification. The PPE includes an apparatus. The apparatus includes a filter and a scrubber unit. The filter that is configured to filter the air for removing dust from the air. The scrubber unit that is configured to purify the air before a user breathes the air. The scrubber unit includes a sparger. The sparger through which the filtered air is bubbled with the help of a pump in a water solution of polymer and other specialty chemicals to trap remaining contaminants in the air and the contaminants free air is sent to the user for breathing.

In some embodiments, the air is sent to the scrubber unit through a first flexible tube.

In some embodiments, the water solution of polymer comprises a water, a solution with chemicals to detoxify and a packed column.

In some embodiments, the contaminants free air is sent to the user through a second flexible tube and the face mask.

In some embodiments, the PPE comprises a battery to operate the scrubber unit.

In some embodiments, the air is inputted to the pump unit for the removing of the dust from the air.

In some embodiments, the PPE removes bacteria and virus from the air before it reaches mouth or nostrils of the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a personal protection equipment (PPE), according to some embodiments herein; and

FIG. 2 illustrates a flow chart of air purification using the personal protection equipment (PPE), according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

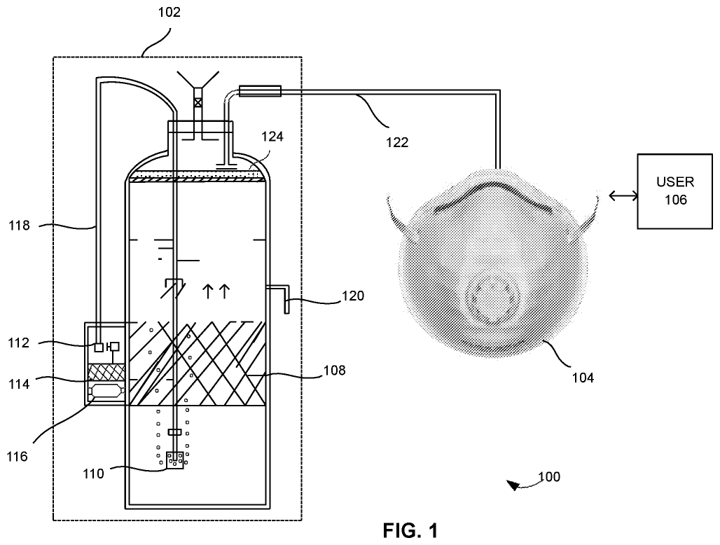

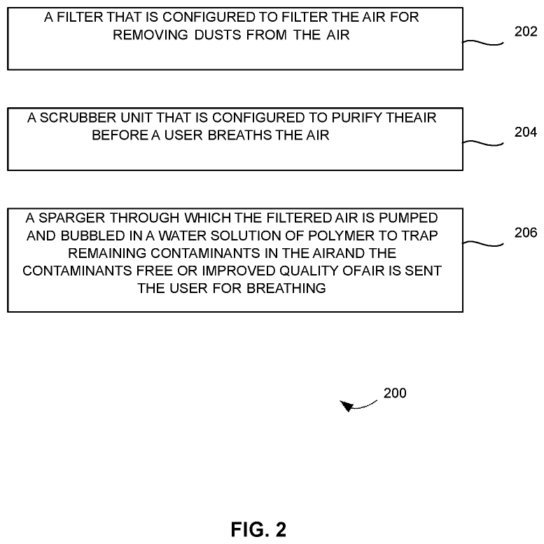

As mentioned, there remains a need for a personal protection equipment (PPE) for air purification. The embodiments herein achieve this by providing the personal protection equipment (PPE) that includes a combination of a filter and a scrubber unit for purifying the air. Referring now to the drawings, and more particularly to FIGS. 1 to 2, where similar reference characters denote corresponding features consistently throughout the figures, there are shown preferred embodiments.

FIG. 1 illustrates a personal protection equipment (PPE) 100, according to some embodiments herein. The personal protection equipment (PPE) 100 includes an apparatus 102, and a user 106 wearing a face mask 104. The apparatus 102 includes a filter 114 and a scrubber unit 108. In some embodiments, the scrubber unit 108 is a diverse group of air pollution control devices that may be used to remove microorganisms and/or harmful viruses from the air. The filter 114 that is configured to filter the air for removing dust from the air. The scrubber unit 108 that is configured to purify the air before the user 106 breaths the air. In some embodiments, the scrubber unit 108 includes a sparger 110 through which the filtered air is pumped and bubbled in a water solution of polymer to trap remaining contaminants from most of unwanted elements in the air and the contaminants free or improved quality air is sent to the user 106 for breathing. In some embodiments, the apparatus 102, may be, for example, but not limited to a plastic bottle, a transparent bottle, a container suitable for holding the water solution of polymer, a non-corrosive metal container, and the like.

In some embodiments, the air is sent to the scrubber unit 108 through a first flexible tube 118. The water solution of polymer includes a water, a solution with chemicals to detoxify and a packed column. The packed column increases an area of contact of the air and the water in the scrubber unit 108. The contaminants free air is sent to the user 106 through a second flexible tube 122 and the face mask 104. The PPE 100 comprises a battery 116 to operate the scrubber unit 108. The air is inputted to an air pump unit 112 through the filter 114 to remove the dust from the air. The pressure in the air pump unit 112 helps the air to pass though the water solution.

In some embodiments, the PPE 100 is portable and operates on two battery types. The two battery types are 1050 R20P—1.5 amperes ratings each, which provide power to the air pump unit 112. The dust free air is pumped towards the scrubber unit 108 at a flow rate of 3-5 LPM. The containment free air is passed through a demister bed 124 where trapped moisture is reduced to a tolerable level. The demister bed 124 removes entrained liquid droplets from the air. The demister bed 124 may be a mesh type coalescers to aggregate the mist into droplets that are heavy enough to separate from a vapor stream.

A maximum relative humidity of air at discharge or delivery point of the PPE observed was tolerable at room temperature of 30 degrees centigrade. The containment free air is then delivered to nostrils of the user 106 through tunings or may be impinged on the face of the user 106 without tube. In some embodiments, the nostrils of the user 106 is called as an inhalation zone. The weight of the water solution of polymer is 250-350 grams/ML. The chemical used in making the water solution contains approximately 1% blend of polymer or esters or surfactants. The chemicals used are not very toxic in nature. The chemicals used have high boiling point and low vapor pressure. No odor nuisance was found as such from the final delivered air coming out from the PPE 100.

In some embodiments, the PPE 100 is portable and low cost. The PPE 100 includes a clip or hook to attach to the user's 106 clothing such as on a belt. The PPE 100 may be used while driving car or a scooter, a motorcycle, a cycle, any vehicle and the like. In some embodiments, if the user 106 wants to use the PPE 100 without wearing the PPE 100 then the user 106 may place the PPE 100 at a distance of approximately 0.5 meter on table or nearby to the user's 106 working place to purify the air around the user 106. The PPE 100 may be used in factories, mines, chemical factories and the like. In some embodiments, PPE 100 may be used to purify the air inside a closed room.

In some embodiments, the nature of the water solution of polymer may be altered accordingly for use in chemical factories depending upon the atmospheric nature or types of fumes. The water solution of polymer may be replaced after use of 24 hours. The water solution of polymer after use should be destroyed in septic tank or soak pit as per local authority norms.

FIG. 2 illustrates a flow chart 200 of air purification using the personal protection equipment (PPE), according to some embodiments herein. At step 202, the air is filtered to remove dust from the air. At step 204, the filtered air is passed through the scrubber unit 108 to purify the air before a user 106 breaths the air. At step 206, the scrubber unit 108 includes a sparger 110 through which the filtered air is pumped and bubbled in a water solution of polymer to trap remaining contaminants in the air and the contaminant free or improved quality air is sent to the user 106 for breathing.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A personal protection equipment (PPE) for air purification, the PPE comprising: an apparatus comprising:
a filter that is configured to filter the air for removing dust from the air; and
a scrubber unit that is configured to purify the air before a user breaths the air,
wherein the scrubber unit comprises:
a sparger through which the filtered air is pumped and bubbled in a water solution of polymer to trap remaining contaminants in the air and the contaminants free or improved quality air is sent the user for breathing.

2. The personal protection equipment (PPE) of claim 1, wherein the air is sent to the scrubber unit through a first flexible tube.

3. The personal protection equipment (PPE) of claim 1, wherein the water solution of polymer comprises a water, a solution with chemicals to detoxify and a packed column.

4. The personal protection equipment (PPE) of claim 1, wherein the contaminants free air is sent to the user through a second flexible tube and a face mask.

5. The personal protection equipment (PPE) of claim 1, wherein the PPE comprises a battery to operate the scrubber unit.

6. The personal protection equipment (PPE) of claim 1, wherein the air is inputted to an air pump unit for the removal of the dust from the air.

7. The personal protection equipment (PPE) of claim 1, wherein the PPE removes bacteria and virus from the air before it reaches mouth or nostrils of the user.
